(19) United States
(12) Patent Application Publication
(10) Pub. No.: US 2019/0253603 A1
(43) Pub. Date: Aug. 15, 2019

(54) IMAGE-CAPTURE DEVICE STATE MONITORING DEVICE, IMAGE-CAPTURE DEVICE STATE MONITORING METHOD, AND PROGRAM

(71) Applicant: Panasonic Intellectual Property Management Co., Ltd., Osaka (JP)

(72) Inventors: SHIGEKAZU MIYAGAKI, Kanagawa (JP); MASANOBU KANAYA, Kanagawa (JP)

(21) Appl. No.: 16/344,834

(22) PCT Filed: Nov. 13, 2017
(86) PCT No.: PCT/JP2017/040730

§ 371 Date: Apr. 25, 2019

(30) Foreign Application Priority Data
Nov. 18, 2016 (JP) 2016-225168

(51) Int. Cl. H04N 5/235; B60R 1/00; B60R 11/02; H04N 17/00

(52) U.S. Cl. CPC H04N 5/2357; B60R 1/00; B60R 2300/30; H04N 17/00; B60R 11/02

(57) ABSTRACT

An imaging apparatus state monitoring device monitors an imaging state of an imaging unit. The imaging apparatus state monitoring device has an image acquisition unit, a blinking determination unit, and an abnormality processor. The image acquisition unit acquires a captured image captured by the imaging unit of which an imaging range includes an image of a blinking and light-emitting unit repeatedly blinking The blinking determination unit determines whether a change corresponding to blinking is included in the captured image. When blinking determination unit determines that no change according to blinking is included in the captured image, the abnormality processor executes abort processing.

### TECHNICAL FIELD

The present disclosure relates to an imaging apparatus state monitoring device, an imaging apparatus state monitoring method, and a program.

### BACKGROUND ART

In recent years, there have been developed various systems for assisting driving by using an in-vehicle camera owing to advance in the camera technology and cost reduction. As one of in-vehicle video display systems using an in-vehicle camera, there is a camera monitoring system in which the in-vehicle camera captures an image of the area outside the vehicle, instead of a conventional optical mirror, and displays the image on a display device. The camera monitoring system has the in-vehicle camera and the display device.

A possible accident that might frequently occur in a camera monitoring system is image freeze. Image freeze is an event that, when a memory controller or control software in the camera monitoring system becomes defective or the image from the in-vehicle camera is not updated due to some failure, the frame memory data to be sequentially updated cannot be updated but the old data continues to be displayed.

When image freeze occurs in the camera monitoring system, an image frame different from the image frame to be displayed appears on the display device. Accordingly, when a driver is unaware of the occurrence of the image freeze, the driver may not recognize an obstacle or the like that is not displayed but actually exists. Therefore, in a camera monitoring system, it is essential to take a measure against image freeze. The same thing can be said to automatic driving systems using images captured by an in-vehicle camera.

As a measure against image freeze, there has been proposed a camera monitoring system that has a means for detecting the presence or absence of image freeze (refer to PTL 1). PTL 1 discloses a method for detecting the presence or absence of image freeze by which an electric control unit (ECU) receives image data and adds identification information of image frames to the image data during the period of blanking of the image data, and comparison of identification information is performed on the display side.

### CITATION LIST

### Patent Literature

### PTL 1: Unexamined Japanese Patent Publication No. 2016-039508

### SUMMARY OF THE INVENTION

The present disclosure provides an imaging apparatus state monitoring device that is improved to detect the presence or absence of image freeze, an imaging apparatus state monitoring method, and a program.

The imaging apparatus state monitoring device according to an aspect of the present disclosure monitors an imaging state of an imaging unit. The imaging apparatus state monitoring device has an image acquisition unit, a blinking determination unit, and an abnormality processor. The image acquisition unit acquires a captured image captured by the imaging unit of which an imaging range includes an image of a blinking and light-emitting unit repeatedly blinking. The blinking determination unit determines whether a change corresponding to blinking is included in the captured image. When blinking determination unit determines that no change according to blinking is included in the captured image, the abnormality processor executes abort processing.

The imaging apparatus state monitoring method according to another aspect of the present disclosure includes a first step of acquiring a captured image, a second step of determining whether a change is included, and a third step of executing abort processing. In the first step of acquiring a captured image, an image of the blinking and light-emitting unit repeatedly blinking captured by the imaging unit is acquired. In the second step of determining whether a change is included, it is determined whether a change corresponding to blinking is included in the captured image. In the third step of executing abort processing, when it is determined that no change corresponding to blinking is included in the captured image, abort processing is executed.

The program according to still another aspect of the present disclosure causes a computer included in an imaging apparatus state monitoring device to execute a first step of acquiring a captured image, a second step of determining whether a change is included, and a third step of executing abort processing. In the first step of acquiring a captured image, an image of the blinking and light-emitting unit repeatedly blinking captured by the imaging unit is acquired. In the second step of determining whether a change is included, it is determined whether a change corresponding to blinking is included. In the third step of executing abort processing, when it is determined that no change corresponding to blinking is included in the captured image, abort processing is executed.

Note that modifications of aspects of the present disclosure that are modified between methods, devices, systems, recording media (including computer-readable non-transient recording media), computer programs, or the like are also effective as the aspects of the present disclosure.

According to the present disclosure, it is possible to provide an imaging apparatus state monitoring device that is improved to detect the presence or absence of image freeze, an imaging apparatus state monitoring method, and a program.

### BRIEF DESCRIPTION OF DRAWINGS

FIG. 1 is a configuration diagram of a camera monitoring system according to a first exemplary embodiment.

FIG. 2 is a diagram illustrating an example of an installation state of the camera monitoring system according to the present disclosure.

FIG. 3 is a flowchart illustrating an example of operations of the camera monitoring system according to the first exemplary embodiment.

FIG. 4A is a diagram illustrating an example of a captured image of a blinking and light-emitting unit in the on state captured by an imaging unit according to the present disclosure.

FIG. 4B is a diagram illustrating an example of a captured image of the blinking and light-emitting unit in the off state captured by the imaging unit according to the present disclosure.

FIG. 5 is a flowchart illustrating an example of processing in step S15 illustrated in FIG. 3.

FIG. 6A is a diagram illustrating a captured image from the imaging unit during normal operation.

FIG. 6B is a diagram illustrating a captured image from the imaging unit in the event of an abnormality.

FIG. 7A is a diagram illustrating a display range of a captured image during normal operation.

FIG. 7B is a diagram illustrating a display range of a captured image in the event of an abnormality.

FIG. 7C is a diagram illustrating an adjusted display range of a captured image in the event of an abnormality.

FIG. 8 is a configuration diagram of a camera monitoring system according to a second exemplary embodiment.

FIG. 9 is a configuration diagram of a camera monitoring system according to a third exemplary embodiment.

FIG. 10 is a diagram illustrating an example of a hardware configuration of a computer.

### DESCRIPTION OF EMBODIMENTS

Prior to describing exemplary embodiments according to the present disclosure, a problem found in a conventional technique will briefly be described. In the configuration described in PTL 1, the ECU has the function of adding identification information of image frames to image data so that it is not possible to detect image freeze caused by the in-vehicle camera in the stage preceding the ECU. In addition, for the in-vehicle camera to perform the function of adding identification information of image frame, it is necessary to change the configuration of the in-vehicle camera, which cannot be attained by making a change to the display.

Hereinafter, exemplary embodiments of the present disclosure will be described in detail with reference to the drawings. First to third exemplary embodiments will be described taking as an example a camera monitoring system to which the imaging apparatus state monitoring device of the present disclosure is applied. However, the present disclosure is not limited to the camera monitoring system. For example, the present disclosure is also applicable to automatic driving systems that refer to images captured by an imaging unit.

### First Exemplary Embodiment

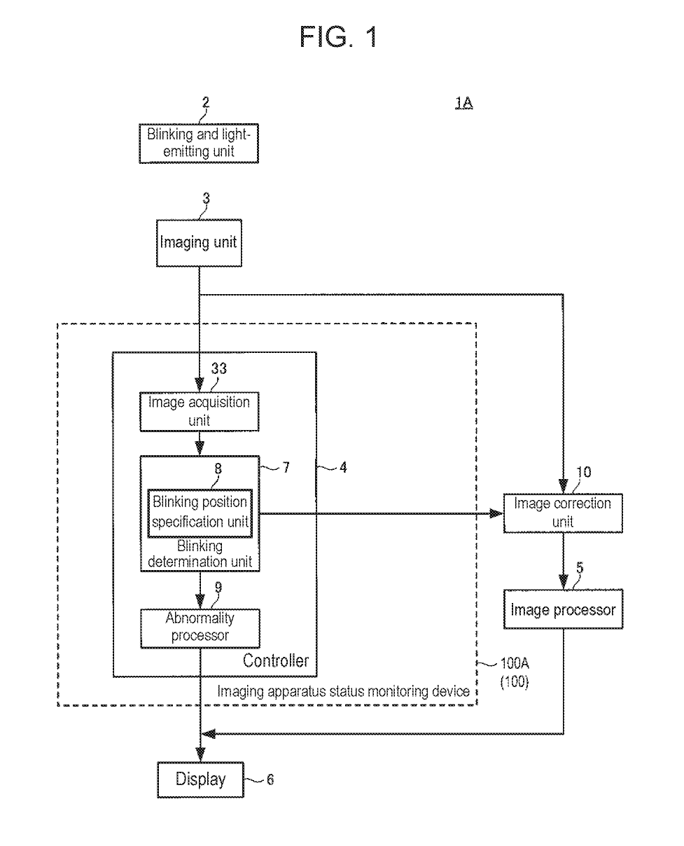

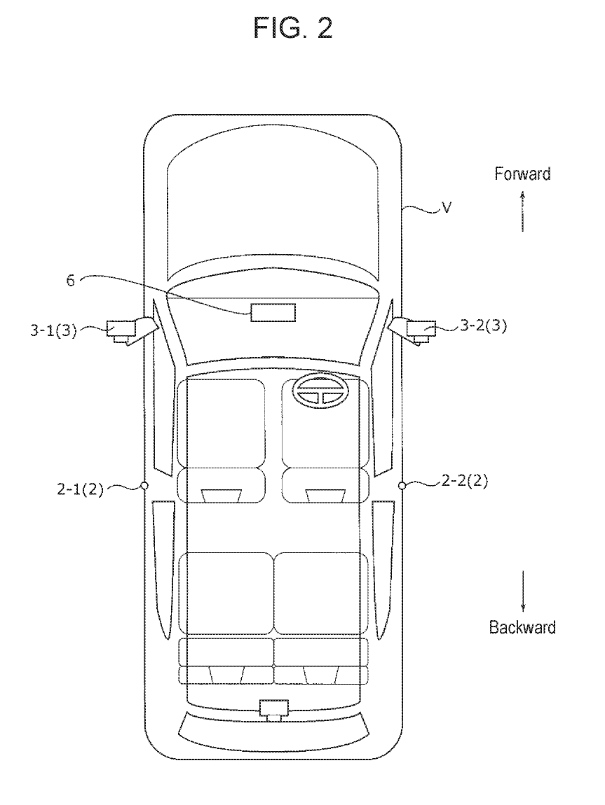

FIG. 1 is a configuration diagram of camera monitoring system 1A according to the first exemplary embodiment. FIG. 2 is a diagram illustrating an example of an installation state of camera monitoring system 1A according to the present disclosure. Camera monitoring system 1A has blinking and light-emitting unit 2, imaging unit 3, controller 4, image processor 5, and display 6. Imaging apparatus state monitoring device 100A (imaging apparatus state monitoring device 100) according to the first exemplary embodiment has at least controller 4 as illustrated in FIG. 1. Imaging apparatus state monitoring device 100A according to the first exemplary embodiment may be built in the same housing as a camera view monitor (display 6) in camera monitoring system 1A, or may be built in the same housing as imaging unit 3, or may be a separate module different from both imaging unit 3 and display 6.

Blinking and light-emitting unit 2 repeats blinking in a predetermined blinking cycle. At least a portion of a light-emission band region of blinking and light-emitting unit 2 is included in an imaging band region of imaging unit 3. In an example, blinking and light-emitting unit 2 has a light emission source as a light emitter capable of blinking, such as a visible light LED emitting visible light or an infrared LED emitting infrared rays. Blinking and light-emitting unit 2 includes LED2-1 and LED2-2 that are provided around left and right door knobs of vehicle V, for example.

In an example, blinking and light-emitting unit 2 is configured such that the light emitter is surrounded by a hood including a low-reflective or light-absorbing material. Accordingly, imaging unit 3 can capture more clearly an image of blinking of blinking and light-emitting unit 2.

In the first exemplary embodiment, blinking and light-emitting unit 2 is provided independently of the other components of camera monitoring system 1A. For example, blinking and light-emitting unit 2 has a battery (not illustrated) and a control circuit (not illustrated) so that the control circuit supplied with power from the battery causes the light emitter supplied with power from the same battery to blink in a predetermined cycle. Blinking and light-emitting unit 2 may not contain such a battery but may be supplied with power from a battery in the vehicle. As blinking and light-emitting unit 2, for example, a blinking light emitter that is included in an antitheft device in the vehicle may be used.

Imaging unit 3 captures images of an imaging range including blinking and light-emitting unit 2 at a predetermined frame rate (for example, 100 frames/second) and generates data of captured images. There is no particular limitation on the imaging range of imaging unit 3 as far as blinking and light-emitting unit 2 and a portion of the vehicle are included in the imaging range. Imaging unit 3 includes, for example, left side view camera 3-1 and right side view camera 3-2 that are included in the vehicle V and are used instead of left and right side mirrors to capture images displayed on the camera view monitor.

Controller 4 includes a central processing unit (CPU), a read only memory (ROM), a random access memory (RAM), and the like. The CPU, for example, reads a program according to a processing content from the ROM, develops the program in the RAM, and centrally controls operation of each block of controller 4 in conjunction with the developed program. Controller 4 acts as blinking determination unit 7, blinking position specification unit 8, abnormality processor 9, and image acquisition unit 33. Controller 4 acquires a captured image via image acquisition unit 33 acquiring a captured image from imaging unit 3. Image acquisition unit 33 is an input interface that receives captured image data transmitted from imaging unit 3.

Image processor 5 processes the captured image from imaging unit 3. In an example, image processor 5 outputs, to display 6 in response to an instruction from image correction unit 10, a display image in which a display range of the captured image from imaging unit 3 is corrected, so that the display image is displayed on display 6. In addition, image processor 5 has publicly known image processing circuits such as a noise filter that removes noise by filtering in a spatial direction, a contrast correction circuit that converts an input image signal into an output image signal according to a gamma curve, and a contour correction circuit that enhances a contour portion, for example. Image processor 5 may be built in the same housing as the camera view monitor (display 6) of camera monitoring system 1A, or may be built in the same housing as imaging unit 3, or may be an independent module different from both imaging unit 3 and display 6.

Display 6 displays the captured image having undergone image processing by image processor 5 to the passenger of the vehicle. Display 6 also acts as a notification unit that notifies the passenger (for example, the driver) of the occurrence of image freeze, an abnormality in blinking and light-emitting unit 2, an abnormality in imaging unit 3, and others. In an example, display 6 is a camera view monitor (display device) included in camera monitoring system 1A. p Blinking determination unit 7 determines whether the captured image acquired from imaging unit 3 includes a change corresponding to blinking of blinking and light-emitting unit 2. In an example, blinking determination unit 7 determines whether blinking and light-emitting unit 2 is blinking based on, out of frames included in the data of the captured image acquired from imaging unit 3 within a predetermined period (for example, one second), the ratio between the number of first frames in which blinking and light-emitting unit 2 is on and the number of second frames in which blinking and light-emitting unit 2 is off. For example, when the ratio is equal to or greater than α and equal to or smaller than 1/α (α is a constant satisfying 0<α≤1), blinking determination unit 7 determines that blinking and light-emitting unit 2 is blinking. In addition, for example, when the ratio is equal to or smaller than β (β is a constant satisfying 0<β≤1), blinking determination unit 7 determines that blinking and light-emitting unit 2 is off. After determining whether blinking and light-emitting unit 2 is blinking, blinking determination unit 7 outputs a signal indicating the determination result to abnormality processor 9.

Blinking position specification unit 8 specifies a blinking position of blinking and light-emitting unit 2 in the captured image from imaging unit 3. In an example, blinking position specification unit 8 specifies the blinking position of blinking and light-emitting unit 2 in the captured image from imaging unit 3 by using coordinates in the captured image. In another example, blinking position specification unit 8 divides the captured image into several areas and specifies the blinking position of blinking and light-emitting unit 2 in the captured image from imaging unit 3 by using the area to which blinking and light-emitting unit 2 belongs. In an example, blinking determination unit 7 uses the blinking position of blinking and light-emitting unit 2 specified by blinking position specification unit 8 to determine whether the blinking and light-emitting unit is on or off in the frames included in the data of the captured image acquired from imaging unit 3.

When an abnormality occurs in blinking and light-emitting unit 2 or imaging unit 3, abnormality processor 9 performs abort processing. The abnormality to be processed is the occurrence of image freeze, an abnormality in blinking and light-emitting unit 2, or an abnormality in imaging unit 3, for example. In this case, an abnormality in blinking and light-emitting unit 2 refers to a malfunctioning state of blinking and light-emitting unit 2 for the reason of breakdown of blinking and light-emitting unit 2 from some cause, attachment of dirt such as mud or snow to blinking and light-emitting unit 2, or the like, for example. An abnormality in imaging unit 3 refers to a state of imaging unit 3 that is displaced from the original setting position or is tilted from some cause, for example. In an example, abnormality processor 9 reboots (restarts or powers off and on again) camera monitoring system 1A (or imaging apparatus state monitoring device 100A) in response to an instruction from blinking determination unit 7. In addition, in an example, abnormality processor 9 causes display 6 acting as a notification unit to display (notify) the abnormal state in response to an instruction from blinking determination unit 7.

Image correction unit 10 corrects the display range of the captured image from imaging unit 3. The display range here is a range of display of the captured image on display 6. In an example, image correction unit 10 corrects the display range of the captured image from imaging unit 3 by instructing image processor 5 to correct the display range. Display 6 acts as a camera view monitor that displays the display image generated by image correction unit 10 to allow the passenger to see the captured image from imaging unit 3. Image correction unit 10 may be built in the same housing as the camera view monitor (display 6) of camera monitoring system 1A, or may be built in the same housing as imaging unit 3, or may be an independent module different from both imaging unit 3 and display 6.

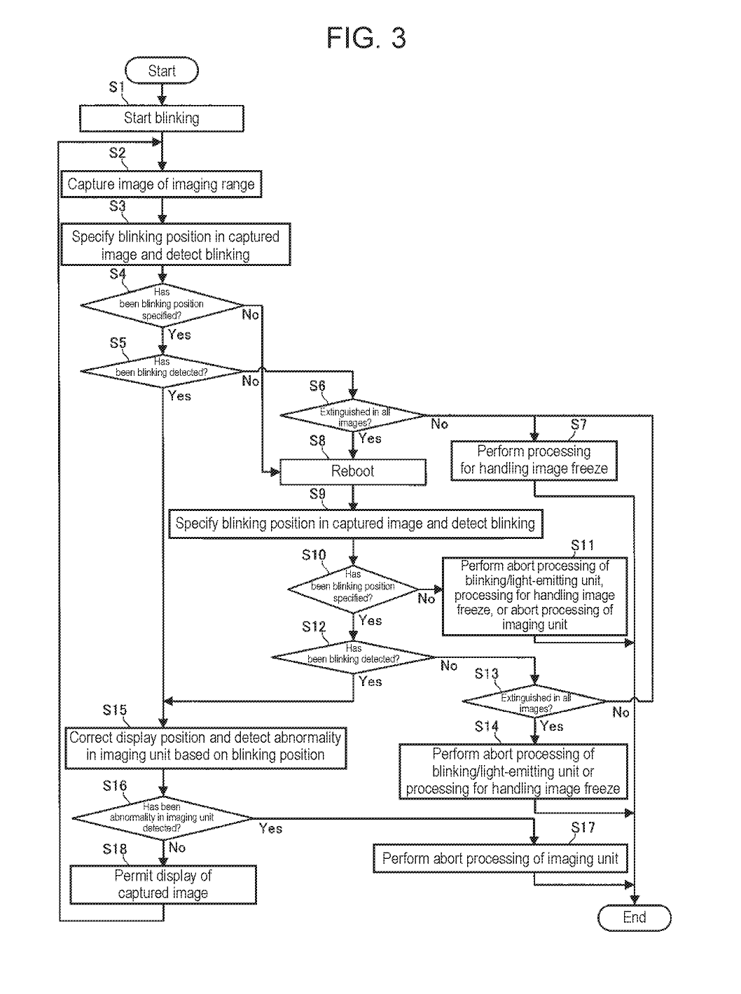

FIG. 3 is a flowchart illustrating an example of operations of camera monitoring system 1A according to the first exemplary embodiment. This processing is implemented by the CPU of camera monitoring system 1A reading the program stored in the ROM and executing the program in response to the start of an engine of the vehicle, for example.

In step S1, blinking and light-emitting unit 2 starts blinking Blinking and light-emitting unit 2 starts blinking when a built-in battery is connected, when an accessory power supply in the vehicle is powered on, or when the engine of the vehicle is started as a trigger. When there is a built-in battery, any one of the three triggers can be used. In the case of being supplied with power from the battery in the vehicle, any one of the two latter triggers can be used. In an example, blinking and light-emitting unit 2 starts blinking at the moment at which blinking and light-emitting unit 2 is connected to the built-in battery regardless of operational state of the engine of the vehicle. In another example, blinking and light-emitting unit 2 starts blinking at the moment at which the accessory power supply in the vehicle is powered on regardless of the operational state of the engine of the vehicle. In another example, blinking and light-emitting unit 2 is supplied with power and starts blinking along with the activation of the engine of the vehicle.

In an example, an imaging cycle (the inverse number of the frame rate) of imaging unit 3 is not an integral multiple of a blinking cycle of blinking and light-emitting unit 2, and the blinking cycle of blinking and light-emitting unit 2 is not an integral multiple of the imaging cycle of imaging unit 3. For example, when the frame rate of imaging unit 3 is 100 frames/second, the imaging cycle is 10 milliseconds, and the blinking cycle of blinking and light-emitting unit 2 is, for example, 21 milliseconds. This makes it possible to avoid blinking determination unit 7 from wrongly determining that blinking and light-emitting unit 2 has broken down due to an overlap between a timing for imaging by imaging unit 3 and a timing for turning off blinking and light-emitting unit 2.

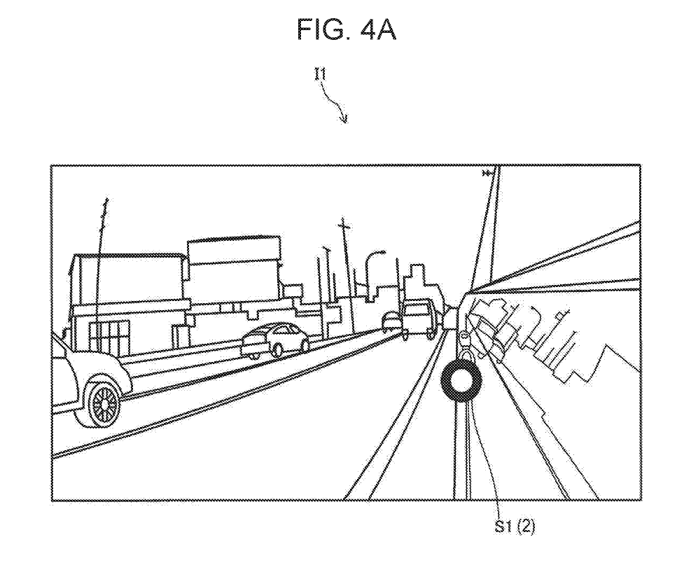

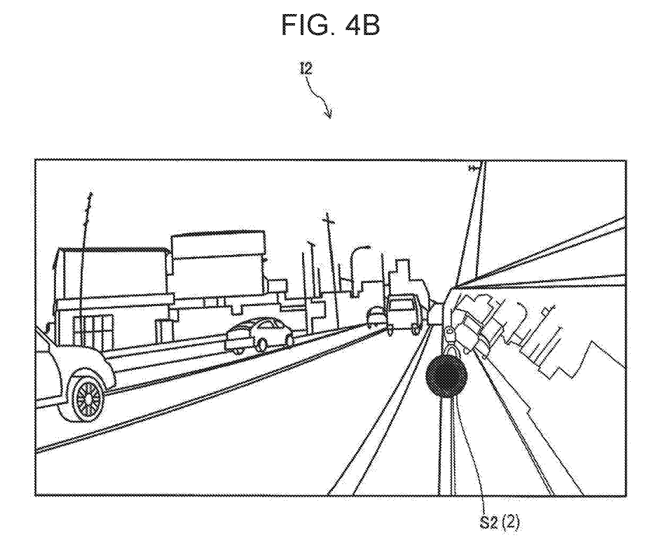

In step S2, imaging unit 3 captures an image of the imaging range. In an example, the imaging range is an area behind the vehicle including a portion of the vehicle. FIG. 4A is a diagram illustrating an example of a captured image of blinking and light-emitting unit 2 in the on state captured by imaging unit 3 according to the present disclosure. In a captured image I1 captured by imaging unit 3, blinking and light-emitting unit 2 is on (state S1). FIG. 4B is a diagram illustrating an example of a captured image of blinking and light-emitting unit 2 in the off state captured by imaging unit 3 according to the present disclosure. In a captured image I2 captured by imaging unit 3, blinking and light-emitting unit 2 is off (state S2). Accordingly, the captured image from imaging unit 3 reflects blinking and light-emitting unit 2 such that it is possible to determine whether blinking and light-emitting unit 2 is blinking.

In step S3, controller 4 specifies the blinking position of blinking and light-emitting unit 2 in the captured images from imaging unit 3, and detects a change corresponding to the blinking (processing by blinking determination unit 7 and blinking position specification unit 8). In an example, blinking position specification unit 8 observes changes in brightness value in each pixel of frames included in the data of the captured images acquired from imaging unit 3 within a predetermined period (for example, one second). Then, blinking position specification unit 8 specifies the pixel with the greatest change in brightness value. Then, blinking position specification unit 8 specifies a position of the pixel as the blinking position of blinking and light-emitting unit 2 in the captured images. Then, blinking determination unit 7 determines whether blinking and light-emitting unit 2 is on or off for each frame based on the brightness value of the pixel at the blinking position specified by blinking position specification unit 8. Instead of making a determination on all the frames, using an integrated value within a certain time or making a determination at intervals of a certain time to reduce a process load.

When the range including the position of blinking and light-emitting unit 2 in the captured images from imaging unit 3 is a presumed range, blinking position specification unit 8 can observe a change in the brightness value only within the presumed range, thereby specifying the blinking position of blinking and light-emitting unit 2 with a smaller amount of calculation. For example, when blinking position specification unit 8 has not specified the blinking position of blinking and light-emitting unit 2 in the presumed range, blinking position specification unit 8 widens a little the presumed range to observe again a change in the brightness value. In addition, for example, when blinking position specification unit 8 has specified the blinking position of blinking and light-emitting unit 2 in the presumed range, blinking position specification unit 8 narrows the presumed range a little for the next observation time.

In step S4, controller 4 determines whether the blinking position has been specified (processing by blinking position specification unit 8). When the blinking position has not been specified (step S4: No), the process proceeds to step S8. On the other hand, when the blinking position has been specified (step S4: Yes), the process proceeds to step S5. In an example, when the blinking position has not been specified (step S4: No), steps S3 and S4 may be repeated a predetermined number of times before proceeding to step S8. This further enhances the accuracy of specification of the blinking position of blinking and light-emitting unit 2.

In step S5, controller 4 determines whether a change corresponding to the blinking of blinking and light-emitting unit 2 has been detected (processing by blinking determination unit 7). When a change corresponding to the blinking has been detected (step S5: Yes), the process proceeds to step S15. On the other hand, when no change corresponding to the blinking has been detected (step S5: No), the process proceeds to step S6. In an example, when no change corresponding to the blinking has been detected (step S5: No), steps S3 to S5 may be repeated a predetermined number of times before proceeding to step S6. This further enhances the accuracy of detection of a change included in the captured images corresponding to the blinking of blinking and light-emitting unit 2.

In step S6, controller 4 determines whether blinking and light-emitting unit 2 is extinguished (turned off) in all the captured images acquired from imaging unit 3 in step S3 (processing by blinking determination unit 7). When controller 4 determines that blinking and light-emitting unit 2 is not extinguished in all the captured images (step S6: No), blinking determination unit 7 determines that image freeze has occurred and the process proceeds to step S7.

In step S7, controller 4 processes image freeze (processing by abnormality processor 9). For example, abnormality processor 9 causes display 6 to display a warning about the occurrence of image freeze. After step

S7 is executed, display 6 displays the warning but does not display the captured image from imaging unit 3. Instead of this, for example, abnormality processor 9 may cause display 6 to display a warning for prompting the passenger to reboot camera monitoring system 1A (or imaging apparatus state monitoring device 100A) or may reboot camera monitoring system 1A.

When controller 4 determines in step S6 that blinking and light-emitting unit 2 is extinguished in all the captured images (step S6: Yes), in addition to the possibility of image freeze, there is a possibility that the turn-on of blinking and light-emitting unit 2 cannot be detected due to an abnormality in blinking and light-emitting unit 2. Accordingly, in step S8, controller 4 reboots camera monitoring system 1A (or imaging apparatus state monitoring device 100A) (processing by abnormality processor 9).

In step S9, controller 4 specifies again the blinking position of blinking and light-emitting unit 2 in the captured images from imaging unit 3, and detects a change corresponding to the blinking (processing by blinking determination unit 7 and blinking position specification unit 8). The operation in step S9 is the same as the operation in step S3 and thus description of step S9 will be omitted.

Next, in step S10, controller 4 determines again whether the blinking position has been specified (processing by blinking position specification unit 8). When the blinking position has not been specified (step S10: No), it is difficult to automatically identify whether the cause is the occurrence of an abnormality in blinking and light-emitting unit 2, image freeze, or an abnormality of the imaging unit 3.

Accordingly, in step S11, controller 4 performs abort processing of abnormality in blinking and light-emitting unit 2, a process of handling image freeze, or abort processing of abnormality in imaging unit 3 (processing by abnormality processor 9). For example, abnormality processor 9 causes display 6 to display a warning for prompting the passenger to check the states of blinking and light-emitting unit 2 and imaging unit 3. This eliminates the need for camera monitoring system 1A to identify which of image freeze, an abnormality in blinking and light-emitting unit 2, or an abnormality in imaging unit 3 has occurred, so that the passenger having received the notification investigates and identifies the cause. After step S11 is executed, display 6 displays the warning but does not display the captured image from imaging unit 3. Instead of this, abnormality processor 9 may cause display 6 to display a warning for prompting the passenger to reboot camera monitoring system 1A (or imaging apparatus state monitoring device 100A) or may reboot camera monitoring system 1A.

On the other hand, when the blinking position has been specified (step S10: Yes), controller 4 determines again in step S12 whether a change corresponding to the blinking of blinking and light-emitting unit 2 has been detected (processing by blinking determination unit 7). When a change corresponding to the blinking has been detected (step S12: Yes), the process proceeds to step S15. On the other hand, when no change corresponding to the blinking has been detected (step S12: No), controller 4 determines again in step S13 whether blinking and light-emitting unit 2 is extinguished in all the captured images acquired from imaging unit 3 in step S9 (processing by blinking determination unit 7).

When controller 4 determines in step S13 that blinking and light-emitting unit 2 is not extinguished in all the captured images (step S13: No), controller 4 determines that image freeze has occurred and the process proceeds to step S7 (processing by blinking determination unit 7). When controller 4 determines in step S13 that blinking and light-emitting unit 2 is extinguished in all the captured images (step S13: Yes), it is difficult to automatically identify whether an abnormality has occurred in blinking and light-emitting unit 2 or image freeze has occurred.

Accordingly, in step S14, controller 4 performs abort processing of blinking and light-emitting unit 2 or a process of handling image freeze (processing by abnormality processor 9). For example, abnormality processor 9 causes display 6 to display a warning for prompting the passenger to check the state of blinking and light-emitting unit 2. This eliminates the need for camera monitoring system 1A to identify which of image freeze and an abnormality in blinking and light-emitting unit 2 has occurred, so that the passenger having received the notification investigates and identifies the cause. After step S14 is executed, display 6 displays the warning but does not display the captured image from imaging unit 3. Instead of this, abnormality processor 9 may cause display 6 to display a warning for prompting the passenger to reboot camera monitoring system 1A (or imaging apparatus state monitoring device 100A) or may reboot camera monitoring system 1A.

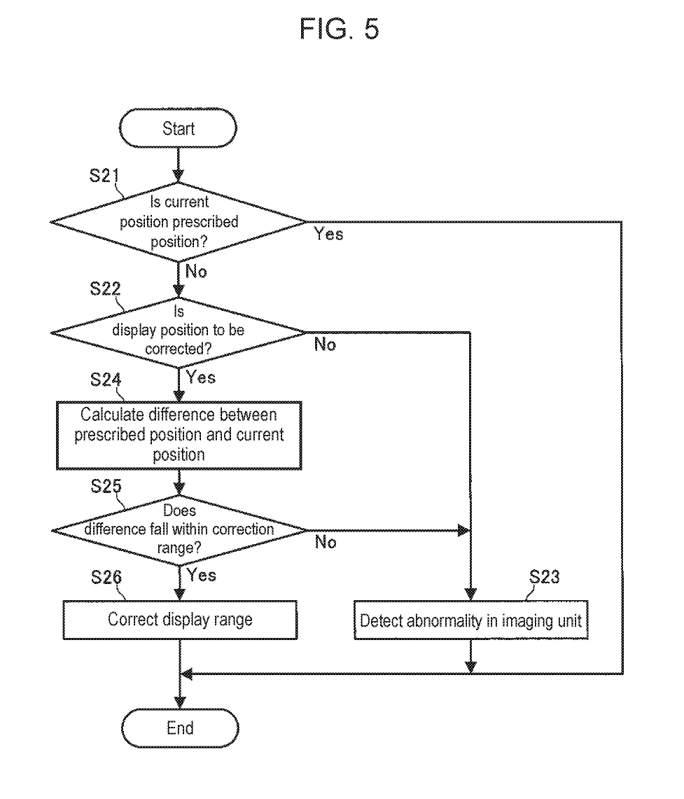

In step S15, controller 4 corrects the display range and detects an abnormality in imaging unit 3 based on the blinking position (processing by blinking determination unit 7 and image correction unit 10). The processing in step S15 will be described later with reference to FIG. 5.

In step S16, controller 4 determines whether an abnormality in imaging unit 3 has been detected (processing by blinking determination unit 7). When determining that an abnormality has been detected (step S16: Yes), controller 4 performs in step S17 abort processing of imaging unit 3 (processing by abnormality processor 9). For example, abnormality processor 9 causes display 6 to display a warning for prompting the passenger to check the state of imaging unit 3. After step S17 is executed, display 6 displays the warning but does not display the captured image from imaging unit 3. Instead of this, abnormality processor 9 may cause display 6 to display a warning for prompting the passenger to reboot camera monitoring system 1A (or imaging apparatus state monitoring device 100A) or may reboot camera monitoring system 1A.

When determining that an abnormality has not been detected (step S16: No), controller 4 permits in step S18 display of the captured image on display 6 (processing by abnormality processor 9). Accordingly, when no abnormality has been detected, the passenger can use display 6 as a camera view monitor. Then, the process returns to step S2.

When camera monitoring system 1A detects the occurrence of an abnormality in blinking and light-emitting unit 2 or image freeze but does not correct the display range or detect an abnormality in imaging unit 3, steps S15 to S17 can be omitted.

FIG. 5 is a flowchart illustrating an example of processing in step S15 illustrated in FIG. 3. This processing is implemented by the CPU of camera monitoring system 1A reading the program stored in the ROM and executing the program in response to the start of an engine of the vehicle, for example.

In step S21, controller 4 determines whether a current position of blinking and light-emitting unit 2 in the captured image from imaging unit 3 is a prescribed position (processing by blinking determination unit 7). In an example, blinking determination unit 7 has a non-volatile memory (not illustrated) in which information indicating the prescribed position of blinking and light-emitting unit 2 (for example, the coordinates or area in the captured image from imaging unit 3) is written in advance. Blinking determination unit 7 reads the information indicating the prescribed position of blinking and light-emitting unit 2 from the non-volatile memory to acquire the prescribed position of blinking and light-emitting unit 2. For example, when camera monitoring system 1A is powered on for the first time, blinking position specification unit 8 specifies the current position of blinking and light-emitting unit 2 in the captured image from imaging unit 3 and writes the specified current position as the prescribed position of blinking and light-emitting unit 2 into the non-volatile memory.

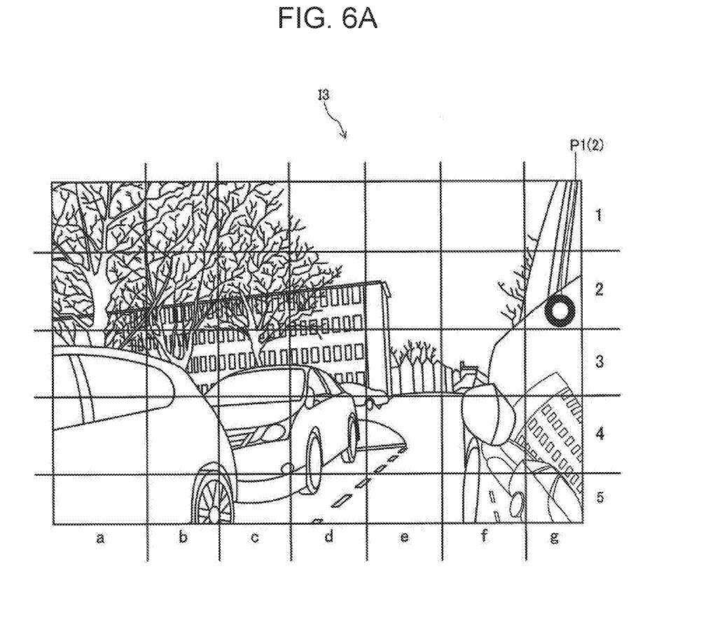

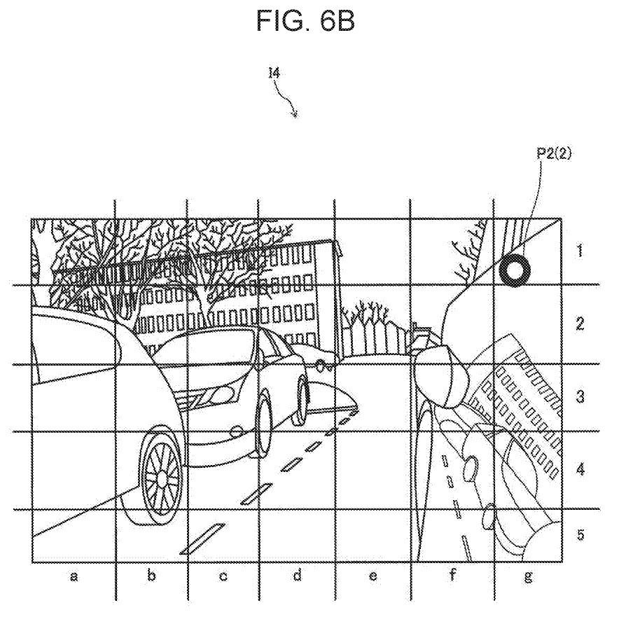

FIG. 6A is a diagram illustrating a captured image I3 from imaging unit 3 during normal operation. FIG. 6B is a diagram illustrating a captured image I4 from imaging unit 3 in the event of an abnormality. Referring to FIG. 6B, imaging unit 3 is inclined downward from some cause as compared to the case during normal operation illustrated in FIG. 6A.

In the captured image I3, the current position of blinking and light-emitting unit 2 is at coordinates P1 and in area g-2. The prescribed position of blinking and light-emitting unit 2 is specified by the same coordinates P1 or the same area g-2 as those of the current position of blinking and light-emitting unit 2 during normal operation. On the other hand, in captured image I4, blinking and light-emitting unit 2 is at coordinates P2 and in area g-1. In this case, the current position of blinking and light-emitting unit 2 is specified by coordinates P2 or area g-1.

In an example, when determining that the distance between coordinates P2 of the current position and coordinates P1 of the prescribed position of blinking and light-emitting unit 2 is larger than a predetermined threshold, blinking determination unit 7 determines that the current position is not the prescribed position. In another example, when determining that area g-2 of the current position is different from area g-1 of the prescribed position of blinking and light-emitting unit 2, blinking determination unit 7 determines that the current position is not the prescribed position.

When blinking determination unit 7 determines that the current position is the prescribed position (step S21: Yes), controller 4 determines that imaging unit 3 is normally operating and terminates step S15 (processing by blinking determination unit 7).

When blinking determination unit 7 determines that the current position is not the prescribed position (step S21: No), controller 4 determines in step S22 whether to correct the display range (processing by image correction unit 10). The display range is a range used as a display image out of the captured image. For example, camera monitoring system 1A has an interface (not illustrated) for causing the passenger to preset whether to correct the display range and determines whether to correct the display range based on the setting.

When camera monitoring system 1A determines that the display range is not corrected (step S22: No), the process proceeds to step S23. In step S23, controller 4 determines that imaging unit 3 has broken down, detects an abnormality in imaging unit 3, and terminates step S15 (processing by blinking determination unit 7).

When camera monitoring system 1A determines that the display range is corrected (step S22: Yes), controller 4 calculates in step S24 a difference (upward, downward, leftward, or rightward displacement) between the prescribed position and the current position of blinking and light-emitting unit 2 in the captured image from imaging unit 3 (processing by blinking determination unit 7). For example, blinking determination unit 7 calculates a horizontal difference and a vertical difference between the coordinates P2 of the current position and the coordinates P1 of the prescribed position of blinking and light-emitting unit 2.

In step S25, controller 4 determines whether the differences are included in a correction range (processing by image correction unit 10). In an example, image correction unit 10 determines whether the differences are included in the correction range based on the currently set position of the display range.

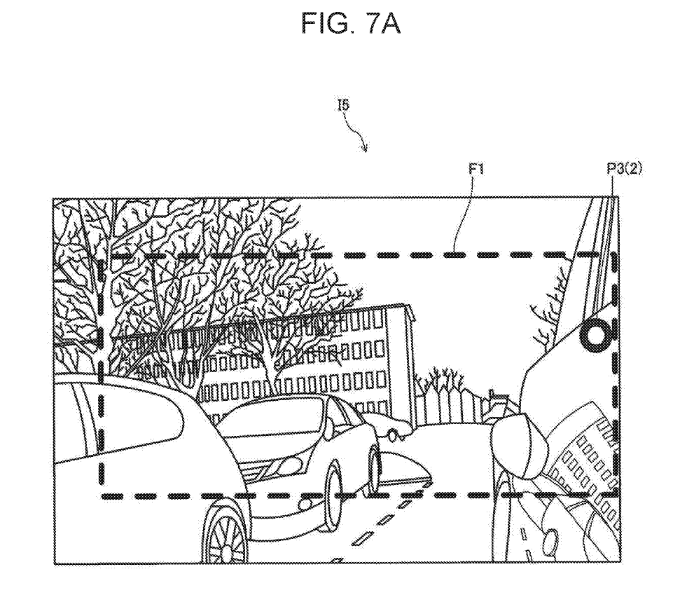

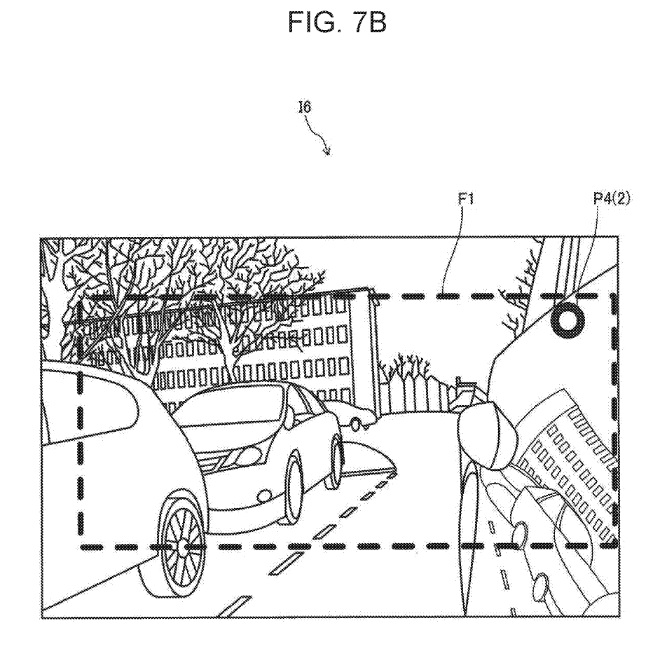

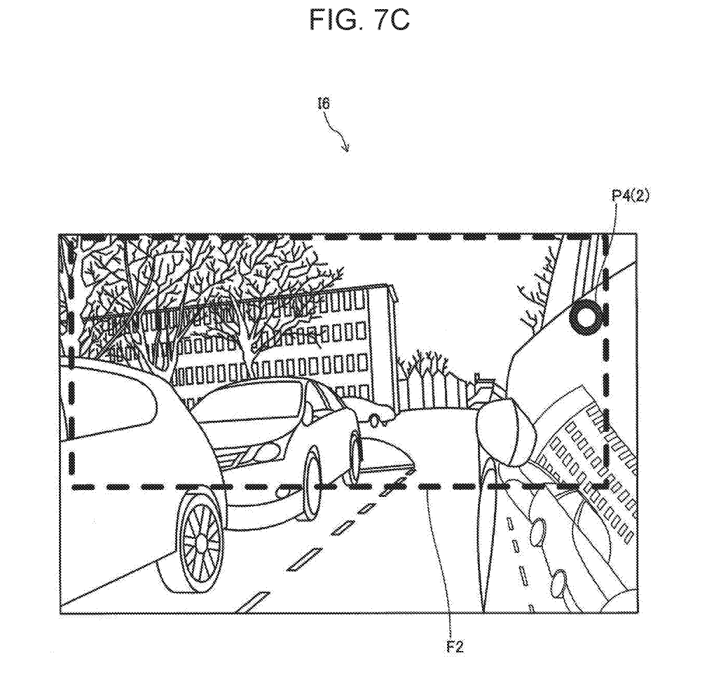

FIG. 7A is a diagram illustrating display range F1 of captured image I5 during normal operation. FIG. 7B is a diagram illustrating display range F1 of captured image I6 in the event of an abnormality. Blinking and light-emitting unit 2 and imaging unit 3 are both fixed to the vehicle and thus the relative positional relationship between these units remains unchanged during normal operation. In the event of an abnormality illustrated in FIG. 7B, imaging unit 3 is inclined downward from some cause (vibration, shock, or the like). In the case illustrated in FIG. 7B, the relative positional relationship changes as compared to the case during normal operation illustrated in FIG. 7A.

As illustrated in FIGS. 7A and 7B, when the same display range F1 is used for both captured image I5 and captured image I6, in the event of an abnormality, the display image is displaced downward in the same manner as the captured image as compared to the normal operating state. Accordingly, first, controller 4 determines whether, when display range F1 is shifted by the difference between coordinates P3 of the prescribed position and coordinates P4 of the current position of blinking and light-emitting unit 2 in the captured image from imaging unit 3, for example, the display range is included in captured image I6 to determine whether the difference is included in the correction range.

When determining that the difference is not included in the correction range (step S25: No), controller 4 determines that imaging unit 3 has broken down and no adjustment is possible, and the process proceeds to step S23 (processing by blinking determination unit 7). On the other hand, when determining that the difference is included in the correction range (step S25: Yes), controller 4 corrects in step S26 the display range (processing by image correction unit 10). In an example, image correction unit 10 corrects the display range by instructing image processor 5 to change the currently set display range in the captured image. In this case, image correction unit 10 may correct the display range such that the image of blinking and light-emitting unit 2 included in the captured image is not included in the display range.

When camera monitoring system 1A detects the occurrence of an abnormality in blinking and light-emitting unit 2 or image freeze and detects the occurrence of an abnormality in imaging unit 3 but does not correct the display range, steps S24 to S26 can be omitted.

FIG. 7C is a diagram illustrating adjusted display range F2 of captured image I6 in the event of an abnormality. Display range F2 displaced from display range F1 by the difference between coordinates P3 of the prescribed position and coordinates P4 of the current position of blinking and light-emitting unit 2 in the captured image from imaging unit 3 is included in captured image I6. The display image determined by display range F2 illustrated in FIG. 7C is the same as the display image determined by display range F1 illustrated in FIG. 7A. This allows camera monitoring system 1A to, even in the event of an abnormality, display the same image as that during normal operation.

In this manner, imaging apparatus state monitoring device 100A (image apparatus state monitoring device 100) according to the first exemplary embodiment monitors the imaging state of imaging unit 3. Imaging apparatus state monitoring device 100A has image acquisition unit 33, blinking determination unit 7, and abnormality processor 9. Image acquisition unit 33 acquires a captured image captured by imaging unit 3 of which an imaging range includes blinking and light-emitting unit 2 repeatedly blinking Blinking determination unit 7 determines whether a change corresponding to blinking is included in the captured image. When blinking determination unit 7 determines that no change corresponding to blinking is included in the captured image, abnormality processor 9 executes abort processing.

Camera monitoring system 1A according to the first exemplary embodiment makes it possible to detect an abnormal state such as the occurrence of image freeze by using blinking and light-emitting unit 2 and the components of the display device, and thus imaging unit 3 such as an in-vehicle camera can be a conventional in-vehicle camera. Further, by determining the presence or absence of image freeze immediately before the display of the display image, camera monitoring system 1A can detect reliably the presence or absence of image freeze in the case of penetration from the in-vehicle camera to the display device.

### Second Exemplary Embodiment

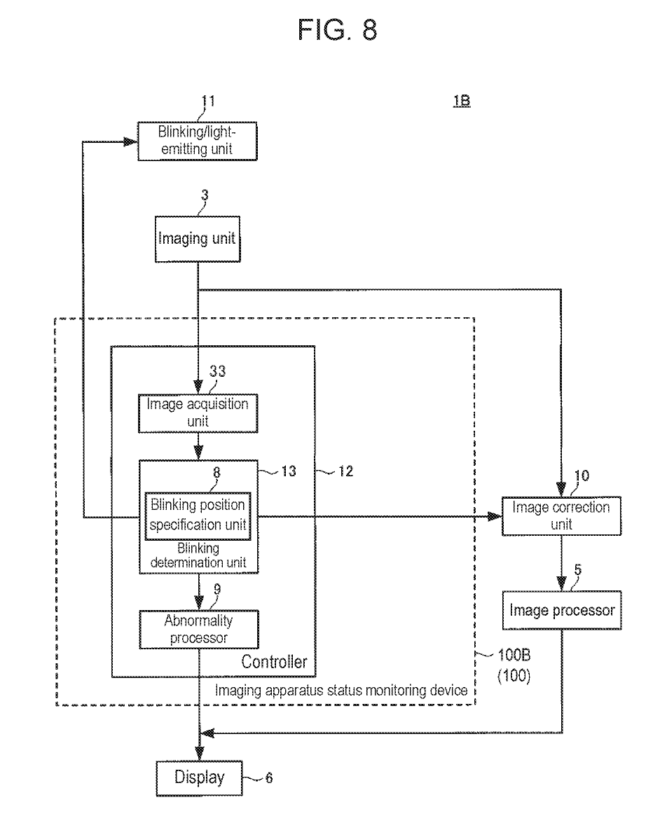

FIG. 8 is a configuration diagram of camera monitoring system 1B according to a second exemplary embodiment. Camera monitoring system 1B according to the second exemplary embodiment has blinking and light-emitting unit 11, imaging unit 3, controller 12, image processor 5, and display 6. Imaging apparatus state monitoring device 100B (imaging apparatus state monitoring device 100) according to the second exemplary embodiment has at least controller 12. Imaging unit 3, image processor 5, and display 6 are the same as those of the first exemplary embodiment and thus descriptions of these units will be omitted.

Controller 12 acts as blinking determination unit 13, blinking position specification unit 8, abnormality processor 9, and image acquisition unit 33. Blinking position specification unit 8, abnormality processor 9, and image acquisition unit 33 are the same as those of the first exemplary embodiment and thus descriptions of these units will be omitted.

Blinking and light-emitting unit 11 repeats blinking. In the first exemplary embodiment, blinking and light-emitting unit 2 is provided independently of the other components of camera monitoring system 1A. In the second exemplary embodiment, blinking and light-emitting unit 11 is connected to blinking determination unit 13 to acquire a signal for specifying a blinking cycle from blinking determination unit 13.

Blinking determination unit 13 determines whether a change corresponding to blinking of blinking and light-emitting unit 11 is included in data of a captured image acquired from imaging unit 3.

As an example, blinking determination unit 13 generates a signal for specifying a blinking cycle based on a frame rate of imaging unit 3. Then, blinking and light-emitting unit 11 acquires the signal generated by blinking determination unit 13 and repeats blinking according to the specified blinking cycle. For example, blinking determination unit 13 selects the blinking cycle such that an imaging cycle of imaging unit 3 is not an integral multiple of a blinking cycle of blinking and light-emitting unit 11 and that the blinking cycle of blinking and light-emitting unit 11 is not an integral multiple of the imaging cycle of imaging unit 3. Accordingly, even when a timing for imaging by imaging unit 3 is variable, it is possible to avoid blinking determination unit 13 from wrongly determining that blinking and light-emitting unit 11 has broken down due to an overlap between the timing for imaging by imaging unit 3 and a timing for turning off blinking and light-emitting unit 11.

When blinking determination unit 13 is connected to a means for determining other outside light (not illustrated), blinking determination unit 13 can generate a signal for instructing for change of illuminance, blinking cycle, or the like of blinking and light-emitting unit 11 according to the outside light. For example, in the daytime when outside light is bright, the illuminance of blinking and light-emitting unit 11 can be changed to be higher or the like. Accordingly, blinking determination unit 13 of camera monitoring system 1B can detect more correctly the blinking of blinking and light-emitting unit 11.

In another example, blinking and light-emitting unit 11 has a power supply circuit (not illustrated) that receives power from the battery of the vehicle and a signal from blinking determination unit 13, and the power supply circuit supplies power for turning on blinking and light-emitting unit 11. This eliminates the need for blinking and light-emitting unit 11 to have a battery for supplying power for turning on. In another example, blinking and light-emitting unit 11 is connected to blinking determination unit 13 by an electric line so that blinking determination unit 13 supplies power for turning on blinking and light-emitting unit 11 via the electric line based on the power from the battery of the vehicle and the signal generated by blinking determination unit 13 itself. This eliminates the need for blinking and light-emitting unit 11 to have a power supply circuit for supplying power for turning on.

As described above, in camera monitoring system 1B according to the second exemplary embodiment, blinking determination unit 13 specifies the blinking cycle to blinking and light-emitting unit 11 based on the frame rate of imaging unit 3.

In camera monitoring system 1B according to the second exemplary embodiment, it is possible to avoid the blinking cycle of blinking and light-emitting unit 11 that cannot be detected by blinking determination unit 13 from the data of the captured image from imaging unit 3 according to the frame rate of imaging unit 3. This allows camera monitoring system 1B to correctly detect an abnormal state such as the occurrence of image freeze in many situations.

### Third Exemplary Embodiment

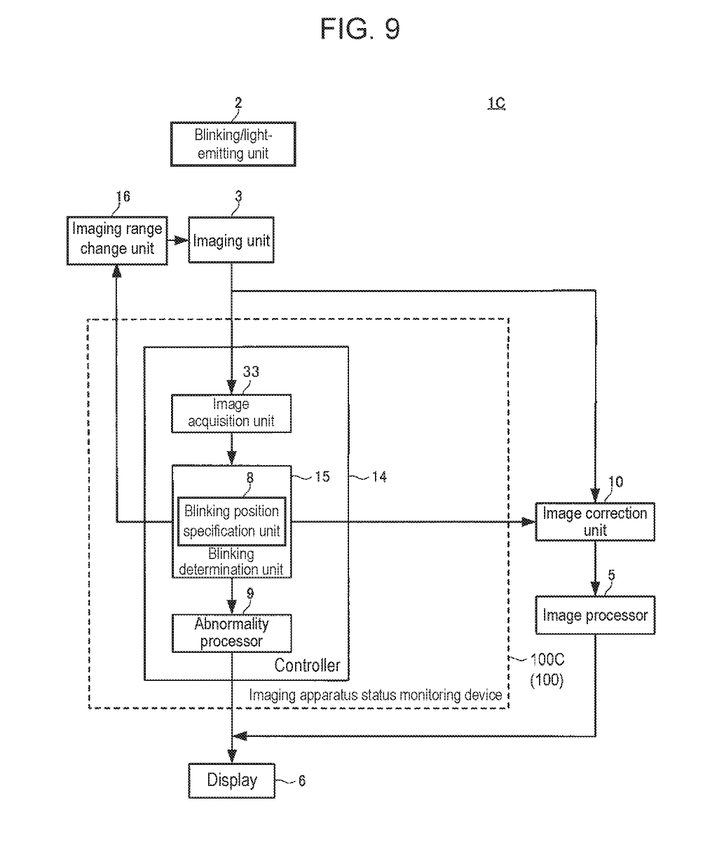

FIG. 9 is a configuration diagram of camera monitoring system 1C according to a third exemplary embodiment. Camera monitoring system 1C according to the third exemplary embodiment has blinking and light-emitting unit 2, imaging unit 3, controller 14, image processor 5, display 6, and imaging range change unit 16. Imaging apparatus state monitoring device 100C (imaging apparatus state monitoring device 100) according to the third exemplary embodiment has at least controller 14. Blinking and light-emitting unit 2, imaging unit 3, image processor 5, and display 6 are the same as those of the first exemplary embodiment and thus descriptions of these units will be omitted.

Controller 14 acts as blinking determination unit 15, blinking position specification unit 8, abnormality processor 9, and image acquisition unit 33. Blinking position specification unit 8, abnormality processor 9, and image acquisition unit 33 are the same as those of the first exemplary embodiment and thus descriptions of these units will be omitted.

Blinking determination unit 15 transmits a signal for changing an imaging range of imaging unit 3 to imaging range change unit 16.

Imaging range change unit 16 changes the imaging range of imaging unit 3 based on the signal acquired from blinking determination unit 15. In an example, imaging range change unit 16 has a motor (not illustrated) that adjusts an orientation of a lens (not illustrated) included in imaging unit 3. The motor is driven by the signal acquired from blinking determination unit 15.

For example, in the event of an abnormality illustrated in FIG. 7B, the lens included in imaging unit 3 faces downward as compared to the case during normal operation illustrated in FIG. 7A. Instead of changing display range F1 into display range F2 illustrated in FIG. 7C in the first exemplary embodiment, in the third exemplary embodiment, the imaging range can be corrected by adjusting the orientation of the lens included in imaging unit 3 as illustrated in FIG. 7A.

In another example, instead of using a motor, imaging range change unit 16 may be configured to, when the imaging range of imaging unit 3 is sufficiently large, cause imaging unit 3 to change a cutout range out of the captured image from imaging unit 3 to generate a new captured image.

In an example, image processor 5 and imaging range change unit 16 perform simultaneously at least one of correction of the display range, change of the cutout range, and change of the imaging range to generate the same display image as the display image in the display range F1 illustrated in FIG. 7A. For example, blinking determination unit 15 instructs imaging range change unit 16 to change the imaging range by area, and image correction unit 10 instructs image processor 5 to shift the display range by the difference between the changed prescribed position and the current position.

As described above, in imaging apparatus state monitoring device 100C (imaging apparatus state monitoring device 100) according to the third exemplary embodiment, blinking determination unit 15 instructs imaging range change unit 16 configured to change the imaging range of imaging unit 3 to change the imaging range of imaging unit 3.

According to camera monitoring system 1C in the third exemplary embodiment, along with correction of the display range by image processor 5, imaging range change unit 16 changes the cutout range or the imaging range, which makes it possible to extend a scope of changing the display range as compared to the case in which only the display range is corrected. This further enhances a degree of freedom of correcting the display image.

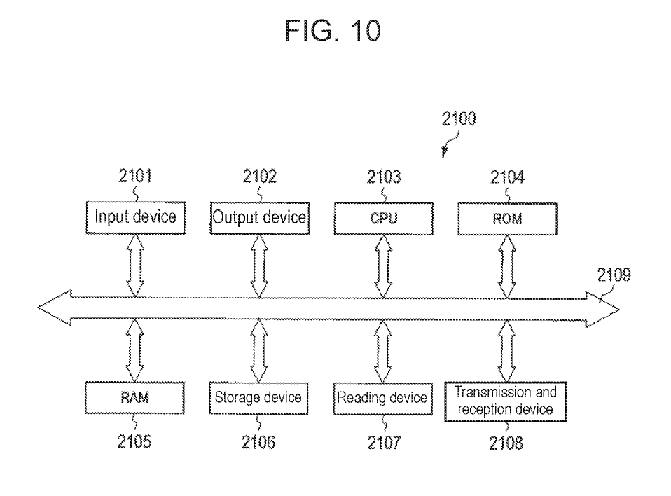

FIG. 10 is a diagram illustrating an example of a hardware configuration of a computer. The functions of components in the above-described exemplary embodiments and modification examples are implemented by a program executed by computer 2100.

As illustrated in FIG. 10, computer 2100 includes: input device 2101 such as input buttons and a touch pad; output device 2102 such as a display and a speaker; central processing unit (CPU) 2103; read only memory (ROM) 2104; and random access memory (RAM) 2105. Computer 2100 further includes: storage device 2106 such as a hard disk device and a solid state drive (SSD); reading device 2107 that reads information from a recording medium such as a digital versatile disk read only memory (DVD-ROM) and a universal serial bus (USB) memory; and a transmission and reception device 2108 that performs communication via a network. The above-described components are interconnected through bus 2109.

Reading device 2107 reads programs from the recording medium on which the programs for realizing functions of the above-described respective parts are recorded and stores the programs in storage device 2106. Alternatively, transmission and reception device 2108 communicates with a server device connected to the network and stores, in storage device 2106, programs for realizing functions of the above-described respective parts which are downloaded from the server device.

CPU 2103 then copies the program stored in storage device 2106 on RAM 2105, sequentially reads commands included in the program from RAM 2105, and performs the read commands, whereby the functions of the respective components are implemented. When the program is executed, information obtained by the various processing described in each exemplary embodiment is stored in RAM 2105 or storage device 2106 and used appropriately.

### Other Exemplary Embodiments

In the first to third exemplary embodiments, blinking and light-emitting unit 2, 11 repeat blinking in the predetermined blinking cycle. Instead of this, in another exemplary embodiment, blinking and light-emitting unit 2, 11 may repeat blinking without a predetermined blinking cycle. In this case, the ratio of the time during which blinking and light-emitting unit 2, 11 is on and the ratio of the time during which blinking and light-emitting unit 2, 11 is off preferably fall within a predetermined range.

In the first to third exemplary embodiments, display 6 acting as a notification unit is a display device included in the camera monitoring system. However, when the present disclosure is applied to a system in which the passenger does not need to see the captured image from imaging unit 3 such as an automatic driving system, for example, the notification unit may not be a display device. For example, instead of display 6, the notification unit may be a speaker that issues a warning sound or a warning voice. In still another example, the notification unit may be a warning lamp. When the notification unit is not a display device, step S18 described in FIG. 3 can be omitted.

In the first to third exemplary embodiments, blinking and light-emitting unit 2, 11 has one light-emitting unit. Instead of this, blinking and light-emitting unit 2, 11 may has a plurality of light emitting units to, when blinking determination unit 7, 13 detects blinking of one of the plurality of light emitting units, determine that the blinking of blinking and light-emitting unit 2, 11 has been detected. Accordingly, even when some of the plurality of light emitting units have broken down or some of the plurality of light emitting units are soiled with dirt such as mud or snow, the camera monitoring systems 1A to 1C according to the present disclosure can continue monitoring for the occurrence of image freeze. Increasing significantly a minimum common multiple cycle of the blinking cycles of the plurality of light emitting units to be longer than the imaging cycle of imaging unit 3 (for example, increasing twice or more) further enhances the detection accuracy of blinking of blinking and light-emitting unit 2, 11.

Imaging apparatus state monitoring device 100A according to the first exemplary embodiment has at least controller 4. Imaging apparatus state monitoring device 100B according to the second exemplary embodiment has at least controller 12. Imaging apparatus state monitoring device 100C according to the third exemplary embodiment has at least controller 14. Instead of this, in another exemplary embodiment, imaging apparatus state monitoring device 100 may have only blinking determination unit 7, 13, or 15 as a minimum component. For example, an in-vehicle device connected to blinking determination unit 7, 13, or 15 of imaging apparatus state monitoring device 100 and disposed outside imaging apparatus state monitoring device 100 may function as abnormality processor 9.

Including a plurality of light emitting units makes it possible to detect and correct not only upward, downward, leftward, and rightward displacements of imaging unit 3 but also displacements of imaging unit 3 due to rotation in planes parallel to upward, downward, leftward, and rightward directions. For example, blinking determination unit 7, 13, 15 determines deviations of gravity centers of two light emitting units at current positions from the prescribed positions in the captured image from imaging unit 3 as upward, downward, leftward, and rightward displacements. Next, blinking determination unit 7, 13, 15 determines rotation angles of the displacements due to the rotation based on orientations of the prescribed positions of the two light emitting units with respect to the gravity centers of the prescribed positions of the two light emitting units and based on orientations of the current positions of the two light emitting units with respect to the gravity centers of the current positions of the two light emitting units. Then, image correction unit 10 corrects the upward, downward, leftward, and rightward displacements and the rotation displacements.

### INDUSTRIAL APPLICABILITY

The imaging apparatus state monitoring device, the imaging apparatus state monitoring method, and the program according to the present disclosure are preferably applied to a camera monitoring system that is mounted on a vehicle instead of mirrors reflecting the surroundings of the vehicle.

### REFERENCE MARKS IN THE DRAWINGS

1A, 1B, 1C: camera monitoring system
2: blinking and light-emitting unit
2-1, 2-2: LED
3: imaging unit
3-1: left side view camera
3-2: right side view camera
4: controller
5: image processor
6: display
7: blinking determination unit
8: blinking position specification unit
9: abnormality processor
10: image correction unit
11: blinking and light-emitting unit
12: controller
13: blinking determination unit
14: controller
15: blinking determination unit
16: imaging range change unit
33: image acquisition unit
100, 100A, 100B, 100C: imaging apparatus state monitoring device
2100: computer
2101: input device
2102: output device
2103: CPU
2104: ROM
2105: RAM
2106: storage device
2107: reading device
2108: transmission and reception device
2109: bus
F1, F2: display range
I1, I2, I3, I4, I5, I6: captured image
P1, P2, P3, P4: coordinates
S1, S2: state
V: vehicle

1. An imaging apparatus state monitoring device that monitors an imaging state of an imaging unit, the imaging apparatus state monitoring device comprising:
an image acquisition unit that acquires a captured image including a plurality of frames captured by the imaging unit;
a blinking determination unit that determines whether a predetermined range of the captured image includes predetermined blinking; and
an abnormality processor that, when the blinking determination unit determines that the predetermined range includes nothing of the predetermined blinking, executes abort processing.

2. The imaging apparatus state monitoring device according to claim 1, wherein the blinking determination unit determines whether the predetermined range in the plurality of frames included in the captured image includes predetermined blinking, based on a number of first frames in which the predetermined range includes lighting and a number of second frames in which the predetermined range includes extinguishing.

3. (canceled)

4. The imaging apparatus state monitoring device according to claim 1, wherein the abort processing is a reboot of the imaging apparatus state monitoring device.

5. The imaging apparatus state monitoring device according to claim 1, wherein the abort processing is causing a notification unit to notify an abnormal state.

6. An imaging apparatus state monitoring system comprising the imaging apparatus state monitoring device according to claim 5, further comprising:
an image correction unit that corrects a display range of the captured image displayed by a display device.

7. The imaging apparatus state monitoring system according to claim 6, wherein the image correction unit corrects the display range such that display of the blinking and light-emitting unit is not included in the display range.

8. The imaging apparatus state monitoring system according to claim 6, wherein
the blinking determination unit includes a blinking position specification unit that specifies a blinking position of the blinking and light-emitting unit in the captured image, and
the image correction unit corrects the display range based on the blinking position.

9. The imaging apparatus state monitoring system according to claim 8, further comprising an imaging range change unit that changes the imaging range of the imaging unit,
wherein the blinking determination unit instructs the imaging range change unit to change the imaging range based on the blinking position.

10. The imaging apparatus state monitoring system according to claim 5, wherein the blinking and light-emitting unit is an infrared LED.

11. The imaging apparatus state monitoring system according to claim 6, wherein
the imaging unit is a camera mounted in a vehicle, and
the blinking and light-emitting unit is provided in the imaging range of the camera in the vehicle.

12. A camera monitoring system comprising the imaging apparatus state monitoring system according to claim 11, wherein
the blinking and light-emitting unit is provided on a side part of the vehicle,
the camera is a side view camera of the vehicle, and
the notification unit is a camera view monitor.

13. An imaging apparatus state monitoring method of an imaging apparatus state monitoring device that monitors an imaging state of an imaging unit, the method comprising:
a first step of acquiring a captured image including a plurality of frames captured by the imaging unit;
a second step of determining whether a predetermined range of the captured image includes predetermined blinking; and
a third step of, when it is determined that the predetermined range of the captured image includes no predetermined blinking, executing abort processing.

14. (canceled)

15. The imaging apparatus state monitoring device according to claim 1, wherein determination on whether the predetermined blinking is made by determining whether a range in which a change in brightness value is largest in the captured image includes lighting or extinguishing in each of the plurality of frames.

16. An imaging apparatus state monitoring system that monitors an imaging state of an imaging unit, the system comprising:
a blinking and light-emitting unit that is placed in an imaging range of the imaging unit and blinks according to a blinking cycle;
an image acquisition unit that acquires a captured image including a plurality of frames captured by the imaging unit;
a blinking determination unit that determines whether a predetermined range includes blinking in the blinking cycle in the captured image; and
an abnormality processor that, when the blinking determination section determines that the predetermined range includes no blinking in the blinking cycle, executes abort processing, wherein
based on a frame rate of the imaging unit, the blinking determination unit specifies the blinking cycle to the blinking and light-emitting unit.

17. The imaging apparatus state monitoring system according to claim 16, wherein the blinking determination unit determines whether the predetermined range includes the predetermined blinking in the plurality of frames included in the captured image, based on a number of first frames in which includes lighting in the predetermined range and a number of second frames in which includes extinguishing in the predetermined range.
